(19) United States
(12) Patent Application Publication
(10) Pub. No.: US 2025/0002375 A1
(43) Pub. Date: Jan. 2, 2025

(54) Self-Cleaning Gas Buster Tank

(71) Applicant: SandTech Holdings LLC, Cheyenne, WY (US)

(72) Inventor: Michael Ray Carr, JR., Midland, TX (US)

(73) Assignee: SandTech Holdings LLC, Cheyenne, WY (US)

(21) Appl. No.: 18/397,550

(22) Filed: Dec. 27, 2023

Related U.S. Application Data
(60) Provisional application No. 63/481,546, filed on Jan. 25, 2023.
(60) Provisional application No. 63/484,687, filed on Feb. 13, 2023.

(51) Int. Cl. C02F 1/40; C02F 1/00; C02F 11/121; C02F 103/10; E21B 43/34

(52) U.S. Cl. CPC C02F 1/40; C02F 1/008; C02F 11/121; E21B 43/35; C02F 2103/10; C02F 2201/008; C02F 2209/40

(57) ABSTRACT

A gas buster tank system, comprising a self-cleaning tank, wherein the self-cleaning tank comprises a gas buster attachment port, one or more silos, wherein each of the one or more silos comprises a valve, one or more skimmers, an excess water port, excess water piping, a clean water exit port, a circulation inlet port, a circulation piping loop, one or more baffles, an exit line, wherein the exit line comprises one or more pipe arms and a discharge port, and a control system; a gas buster attachment, wherein the gas buster attachment is attached to the gas buster attachment port; a trailer; and a pump trailer, wherein the pump trailer comprises a first pump attached to the circulation inlet port and a second pump attached to the discharge port.

### CROSS-REFERENCE TO RELATED APPLICATIONS

This application claims priority to U.S. Provisional Application No. 63/481,546 filed on Jan. 25, 2023, and U.S. Provisional Application No. 63/484,687 filed on Feb. 13, 2023, the disclosures of which are herein incorporated by reference in their entirety.

### STATEMENT REGARDING FEDERALLY SPONSORED RESEARCH OR DEVELOPMENT

Not applicable.

### BACKGROUND

### 1. Field of Inventions

The field of this application and any resulting patent is methods and systems for processing gas, liquids, and solids removed from a wellbore after various downhole operations, such as fracking.

### 2. Description of Related Art

Various methods and systems have been proposed and utilized for processing gas, liquids, and solids removed from a wellbore after various downhole operations, including some of the methods and systems disclosed in the references appearing on the face of this patent. However, those methods and systems lack all the steps or features of the methods and systems covered by any patent claims below. As will be apparent to a person of ordinary skill in the art, any methods and systems covered by claims of the issued patent solve many of the problems that prior art methods and systems have failed to solve. Also, the methods and systems covered by at least some of the claims of this patent have benefits that could be surprising and unexpected to a person of ordinary skill in the art based on the prior art existing at the time of invention.

### SUMMARY

One or more specific embodiments disclosed herein includes a gas buster tank system, comprising a self-cleaning tank, wherein the self-cleaning tank comprises a gas buster attachment port, one or more silos, wherein each of the one or more silos comprises a valve, one or more skimmers, an excess water port, excess water piping, a clean water exit port, a circulation inlet port, a circulation piping loop, one or more baffles, an exit line, wherein the exit line comprises one or more pipe arms and a discharge port, and a control system; a gas buster attachment, wherein the gas buster attachment is attached to the gas buster attachment port; a trailer; and a pump trailer, wherein the pump trailer comprises a first pump attached to the circulation inlet port and a second pump attached to the discharge port.

One or more specific embodiments disclosed herein includes a method of processing gas, liquids, and solids removed from a wellbore, comprising providing a gas buster tank system comprising a self-cleaning tank, wherein the self-cleaning tank comprises a gas buster attachment port, one or more silos, wherein each of the one or more silos comprises a valve, one or more skimmers, an excess water port, excess water piping, a clean water exit port, a circulation inlet port, a circulation piping loop, one or more baffles, an exit line, wherein the exit line comprises one or more pipe arms and a discharge port, and a control system, a gas buster attachment, wherein the gas buster attachment is attached to the gas buster attachment port, a trailer, and a pump trailer, wherein the pump trailer comprises a first pump attached to the circulation inlet port and a second pump attached to the discharge port; pumping materials from a wellbore, wherein the materials comprise sand, debris, water, and liquid chemicals; directing the materials to the gas buster attachment, wherein the gas buster attachment separates gas from the materials; directing the remaining materials to the self-cleaning tank, wherein the materials are deposited in the one or more silos; holding the chemicals in the materials back by employing the one or more skimmers while allowing the water in the materials to proceed through the excess water port, wherein the water exits the self-cleaning tank via the clean water exit port; attaching the first pump to the circulation inlet port, wherein water is pumped into the circulation piping loop, wherein it is sent through the perimeter jets and valve jets to mix with the sand in the one or more silos; actuating the one or more silo valves allowing the sand mixture to move into the one or more pipe arms and into the exit line; and attaching the second pump to the discharge port to pump the sand mixture out of the self-cleaning tank.

### BRIEF DESCRIPTION OF THE DRAWINGS

FIG. 1A shows a side view of an embodiment of a gas buster tank system.

FIG. 1B shows a perspective view of an embodiment of a pump trailer.

FIG. 2 shows a perspective view of an embodiment of a gas buster attachment.

FIG. 3 shows a side view of an embodiment of a self-cleaning tank.

FIG. 4A shows a perspective view of an embodiment of the inside of a silo.

FIG. 4B shows another view of an embodiment of the inside of a silo.

FIG. 4C shows a side view of an embodiment of the tops of silos.

FIG. 4D shows a perspective view of an embodiment of a silo.

FIG. 5 shows a perspective view of an embodiment of the bottom of a self-cleaning tank.

FIG. 6A shows an embodiment of a flow meter valve and clamps.

FIG. 6B shows an embodiment of a flow meter display.

FIG. 7A shows an embodiment of a self-cleaning tank with components of the control system.

FIG. 7B shows an embodiment of a self-cleaning tank with additional components of the control system.

FIG. 8A shows a back perspective view of an embodiment of a trailer.

FIG. 8B shows a side view of an embodiment of a trailer.

FIG. 8C shows an embodiment of a stabilizer for a trailer.

FIG. 9 shows a perspective view of an embodiment of a dewatering roll off gas buster.

FIG. 10 shows a perspective view of an alternative embodiment of a dewatering roll off gas buster.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in any printed publication, dictionary, or issued patent.

### 2. Certain Specific Embodiments

Now, certain specific embodiments are described, which are by no means an exclusive description of the inventions. Other specific embodiments, including those referenced in the drawings, are encompassed by this application and any patent that issues therefrom.

One or more specific embodiments disclosed herein includes a gas buster tank system, comprising a self-cleaning tank, wherein the self-cleaning tank comprises a gas buster attachment port, one or more silos, wherein each of the one or more silos comprises a valve, one or more skimmers, an excess water port, excess water piping, a clean water exit port, a circulation inlet port, a circulation piping loop, one or more baffles, an exit line, wherein the exit line comprises one or more pipe arms and a discharge port, and a control system; a gas buster attachment, wherein the gas buster attachment is attached to the gas buster attachment port; a trailer; and a pump trailer, wherein the pump trailer comprises a first pump attached to the circulation inlet port and a second pump attached to the discharge port.

A method of processing gas, liquids, and solids removed from a wellbore, comprising providing a gas buster tank system comprising a self-cleaning tank, wherein the self-cleaning tank comprises a gas buster attachment port, one or more silos, wherein each of the one or more silos comprises a valve, one or more skimmers, an excess water port, excess water piping, a clean water exit port, a circulation inlet port, a circulation piping loop, one or more baffles, an exit line, wherein the exit line comprises one or more pipe arms and a discharge port, and a control system, a gas buster attachment, wherein the gas buster attachment is attached to the gas buster attachment port, a trailer, and a pump trailer, wherein the pump trailer comprises a first pump attached to the circulation inlet port and a second pump attached to the discharge port; pumping materials from a wellbore, wherein the materials comprise sand, debris, water, and liquid chemicals; directing the materials to the gas buster attachment, wherein the gas buster attachment separates gas from the materials; directing the remaining materials to the self-cleaning tank, wherein the materials are deposited in the one or more silos; holding the chemicals in the materials back by employing the one or more skimmers while allowing the water in the materials to proceed through the excess water port, wherein the water exits the self-cleaning tank via the clean water exit port; attaching the first pump to the circulation inlet port, wherein water is pumped into the circulation piping loop, wherein it is sent through the perimeter jets and valve jets to mix with the sand in the one or more silos; actuating the one or more silo valves allowing the sand mixture to move into the one or more pipe arms and into the exit line; and attaching the second pump to the discharge port to pump the sand mixture out of the self-cleaning tank.

One or more specific embodiments disclosed herein includes one or more silos wherein each of the one or more silos comprises a rectangular section and a V-shaped section.

One or more specific embodiments disclosed herein includes a clean water exit port comprising one or more butterfly valves.

One or more specific embodiments disclosed herein includes a circulation piping loop comprising a plurality of circulation valves, a plurality of perimeter jets, and a plurality of valve jets.

One or more specific embodiments disclosed herein includes a system comprising a flow meter system, wherein the flow meter system comprises an inlet pipe, a flow meter, Victaulic clamps, one or more flow valves, a flow meter display, and a return pipe.

One or more specific embodiments disclosed herein includes a method wherein the water exits the clean water exit port and proceeds to a plant to be treated and reused.

One or more specific embodiments disclosed herein includes a method wherein the circulation valves control the flow of water into the one or more silos.

One or more specific embodiments disclosed herein includes a method wherein the sand mixture is sent to a pit.

One or more specific embodiments disclosed herein includes a method wherein the sand mixture is sent to a dewatering roll off gas buster.

One or more specific embodiments disclosed herein includes a system comprising a plurality of silos.

One or more specific embodiments disclosed herein includes baffles that permit clean water to move between the plurality of silos.

### 3. Specific Embodiments in the Figures

The drawings presented herein are for illustrative purposes only and are not intended to limit the scope of the claims. Rather, the drawings are intended to help enable one having ordinary skill in the art to make and use the claimed inventions.

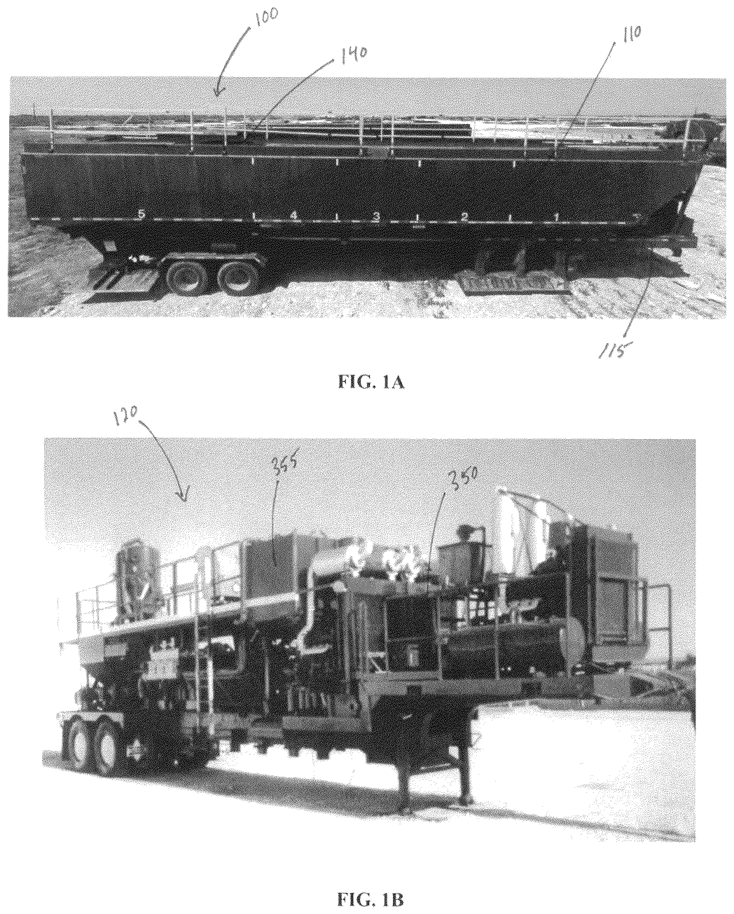

Referring to FIGS. 1-8C, a specific embodiment, e.g., version or example, of a system for processing gas, liquids, and solids removed from a wellbore after various downhole operations, such as fracking, is illustrated. These figures may show features which may be found in various specific embodiments, including the embodiments shown in this specification and those not shown.

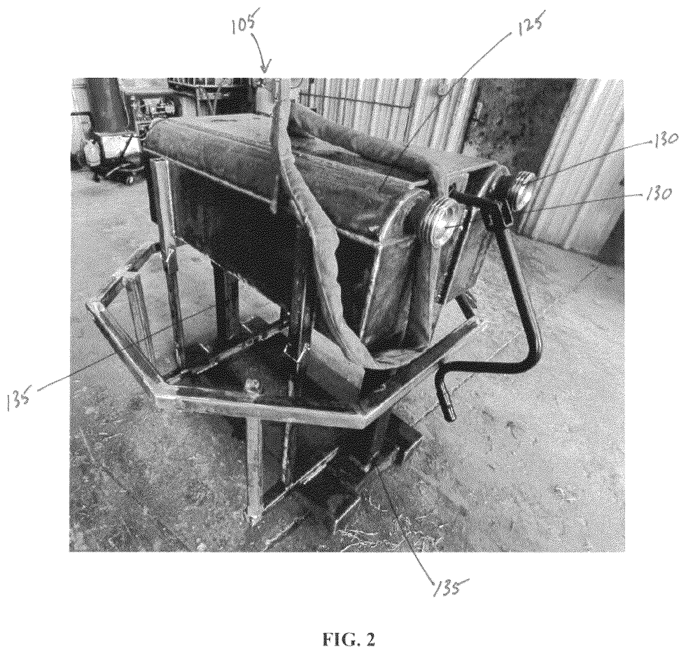

FIG. 1A shows an embodiment of a gas buster tank system 100. In embodiments, the gas buster tank system 100 may comprise a gas buster attachment 105 (see FIG. 2), a self-cleaning tank 110, a trailer 115, and a pump trailer 120. FIG. 1B shows an embodiment of the pump trailer 120.

FIG. 2 shows an embodiment of the gas buster attachment 105. In embodiments, the gas buster attachment 105 may comprise a double gas buster 125, one or more inlets 130, and one or more gas buster jacks 135. In embodiments, the one or more inlets 130 may comprise 15,000-PSI 2-inch inlets. Further, in embodiments the one or more inlets 130 may comprise two inlets. In embodiments, the gas buster attachment 105 may act as a separator to remove gas from fluids circulated in the wellbore. Additionally, the gas buster attachment 105 may be positioned on top of the self-cleaning tank 110 at a gas buster attachment port 140 in FIG. 1A.

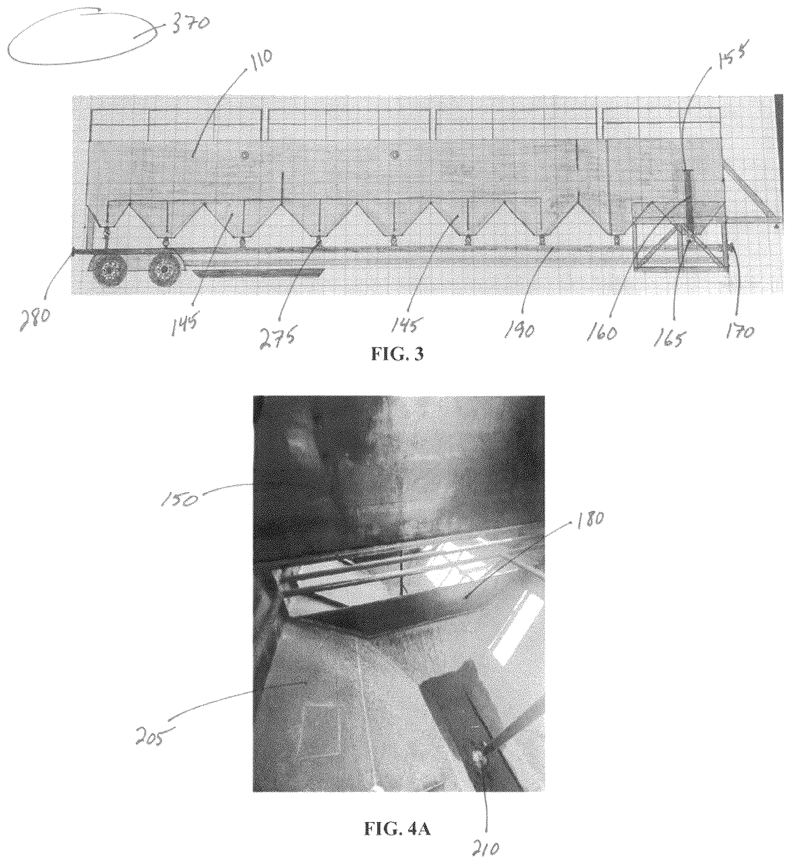

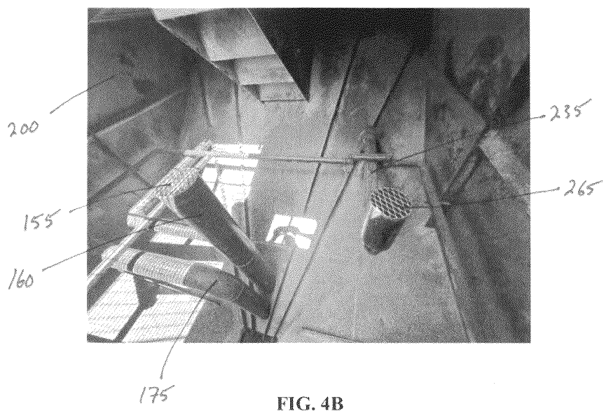

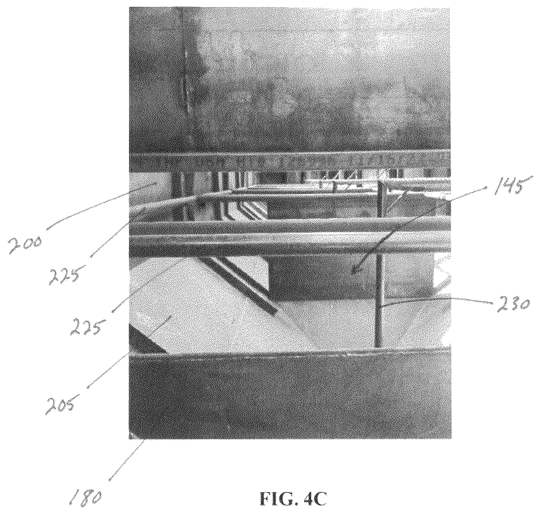

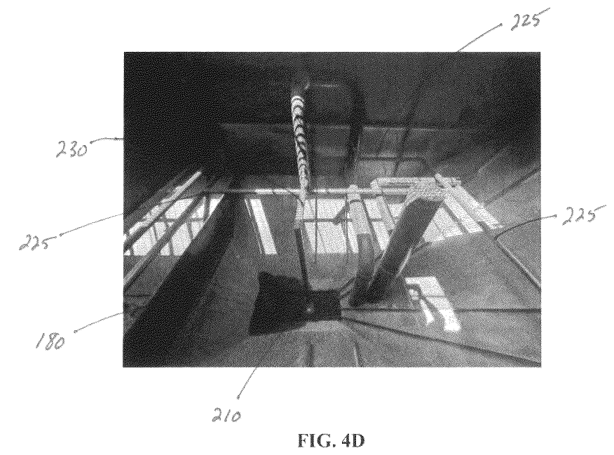

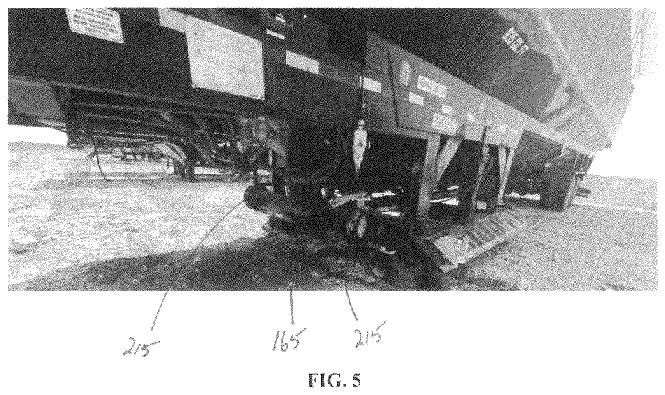

FIG. 3 shows an embodiment of the self-cleaning tank 110. FIG. 4A shows an embodiment of the inside of one or more silos 145. FIG. 4B shows another view of an embodiment of the inside of one or more silos 145. FIG. 4C shows a side view of the tops of one or more silos 145. FIG. 4D shows a view of an embodiment of one or more silos 145. In embodiments, the self-cleaning tank 110 may comprise the gas buster attachment port 140 (see FIG. 1A), one or more silos 145, one or more skimmers 150, one or more excess water ports 155, excess water piping 160, a clean water exit port 165, a circulation inlet port 170, a circulation piping loop 175, one or more baffles 180, a flow meter system 185, an exit line 190, and a control system 195.

As also shown in FIG. 1A, in embodiments the gas buster attachment port 140 may be positioned on top of the self-cleaning tank 110. In embodiments, the gas buster attachment 105 may be installed into the gas buster attachment port 140.

In embodiments, each of the one or more silos 145 may comprise a rectangular section 200, a V-shaped section 205, and a silo valve 210. As shown in FIG. 4C, for example, in an embodiment of a single silo 145, the rectangular section 200 may be located higher than the V-shaped section 205. Thus, in embodiments the rectangular section 200 may form a cuboid, and the V-shaped section 205 may form an inverted pyramid. In embodiments, this arrangement may apply to a plurality of silos 145 as well. In embodiments, the one or more silos 145 may be positioned next to each other in series as shown in FIG. 3. Further, in embodiments the silo valve 210 for each of the one or more silos 145 may be located at the bottom of the inverted pyramid of the V-shaped section 205 as shown in FIG. 4A. In embodiments, the silo valve 210 may be opened and closed. In embodiments, the silo valve 210 may be hydraulically operated and controlled. In alternative embodiments, the rectangular section 200 may be in the shape of a square so that the section 200 may form a cube.

In embodiments, each of the one or more skimmers 150 may comprise a rectangular shape as shown in FIG. 4A. Alternatively, in embodiments each of the one or more skimmers 150 may comprise a square shape. In embodiments, each of the one or more skimmers 150 may be located higher than the one or more silos 145. Further, in embodiments the one or more skimmers 150 may be employed to remove chemicals from the sand mixture. In embodiments, the one or more skimmers 150 may descend into the sand mixture. In embodiments, any chemicals in the sand mixture may be lighter than any water in the sand mixture and float to the top of the sand mixture. Thus, in embodiments, the one or more skimmers 150 may descend sufficiently into the sand mixture to separate the chemicals from the sand mixture.

In embodiments, each of the one or more excess water ports 155 may comprise a screen to prevent and/or discourage debris from entering the excess water piping 160 as shown in FIG. 4B. In embodiments, one excess water port 155 may be located in each of the one or more silos 145. In embodiments, each of the one or more excess water ports 155 may be located at an appropriate height so that mainly clean water may enter the one or more excess water ports 155. In embodiments, each of the one or more excess water ports 155 may lead to the excess water piping 160. In embodiments, the excess water piping 160 may lead to the clean water exit port 165. In embodiments, the clean water exit port 165 may allow the clean excess water to be removed from the self-cleaning tank 110. In embodiments, the clean water exit port 165 may comprise one or more valves 215 as shown in FIG. 5. In embodiments, each of the one or more valves 215 may comprise a butterfly valve. In embodiments, each of the one or more valves 215 may be connected to a pump (not shown) by piping or hoses, wherein the clean water exiting the self-cleaning tank 110 may be sent back into the circulation piping loop 175.

In embodiments, the circulation inlet port 170 may lead to the circulation piping loop 175. In embodiments, the circulation piping loop 175 may lead to a plurality of perimeter jets 225 and a plurality of valve jets 230 as shown in FIGS. 4C and 4D. Further, in embodiments the circulation piping loop 175 may comprise a plurality of circulation valves 235, wherein the plurality of circulation valves 235 may control the flow of water into the one or more silos 145. In embodiments, the water that is sent into the one or more silos 145 through the perimeter jets 225 and the valve jets 230 may combine with the sand in the silos 145 to create a mixture that is movable, which may be referred to herein as the sand mixture. In embodiments, the circulation piping loop 175 may comprise pipes with diameters of 4 inches and 6 inches. In embodiments, the circulation valves 235 may comprise jet ball valves.

Returning to FIG. 4A, in embodiments, the one or more baffles 180 may be employed to distribute water between or among the silos 145 when there is a plurality of silos 145. In embodiments, each of the one or more baffles 180 may be positioned lower than the skimmers 150. In embodiments, each of the one or more baffles 180 may comprise a parallelogram shape with a longer base on top. In embodiments, each of the one or more baffles 180 may abut the V-shaped section 205 of one of the silos 145. In other embodiments, each of the one or more baffles 180 may form a part of the V-shaped section 205.

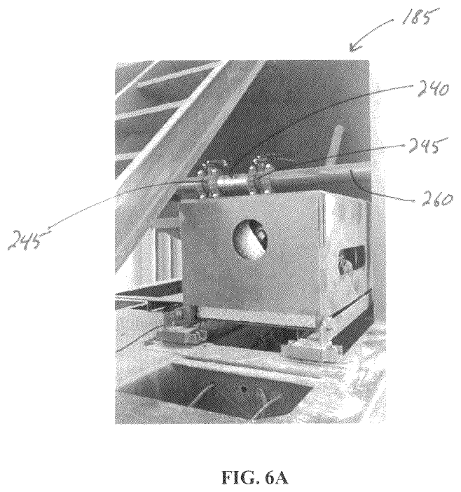

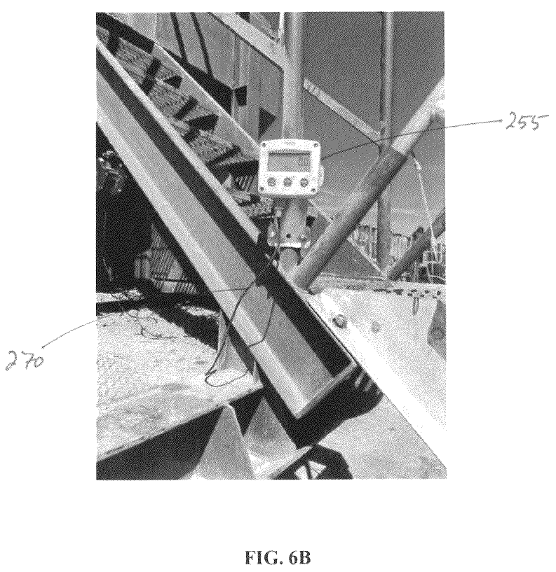

In embodiments, the flow meter system 185 may comprise an inlet pipe 235 (see FIG. 4B), a flow meter 240 (see FIG. 6A), one or more Victaulic clamps 245 (see FIG. 6A), one or more flow valves 250 (not shown), a flow meter display 255 (see FIG. 6B), and return pipe 260. In embodiments, the inlet pipe 235 may comprise a flow meter port 265. In embodiments, the flow meter port 265 may be lower than the excess water port 155. Further, in embodiments the flow meter port 265 may comprise a screen to prevent and/or discourage debris from entering the flow meter port 265. In embodiments, the flow meter display 255 may comprise wiring 270, wherein the wiring 270 may electrically connect the flow meter display 255 to the flow meter 240. In embodiments, the flow meter 240 may comprise a 4-inch flow meter. Further, in embodiments the inlet pipe 235 may allow for the sand mixture to proceed from the silos 145 to the flow meter 240, and the return pipe 260 may allow for the sand mixture to return to the silos 145.

Returning to FIG. 3, in embodiments, the exit line 190 may comprise one or more pipe arms 275 and a discharge port 280. In embodiments, each of the one or more pipe arms 275 may be connected to the exit line 190. In embodiments, each silo valve 210 may be connected to one of the one or more pipe arms 275. In embodiments, when each silo valve 210 is opened, the sand mixture may proceed through the silo valve 210, through the connected pipe arm 275, and into the exit line 190. In embodiments, the sand mixture may proceed down the exit line 190 until is leaves the self-cleaning tank 110 through the discharge port 280. In embodiments, upon leaving through the discharge port 280, the sand mixture may be pumped to a pit 370 or to a dewatering roll off gas buster 400, which is discussed below.

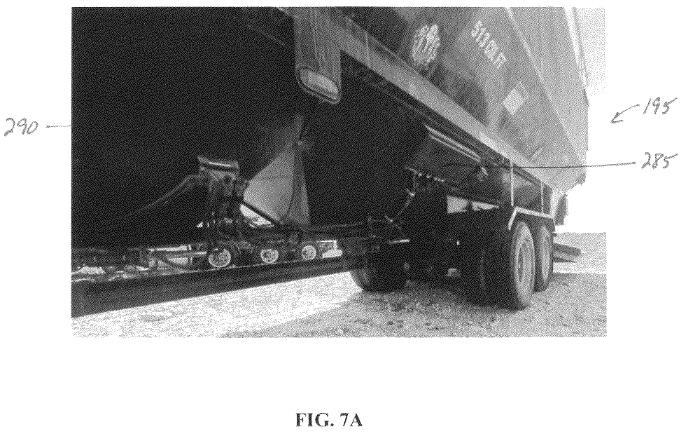

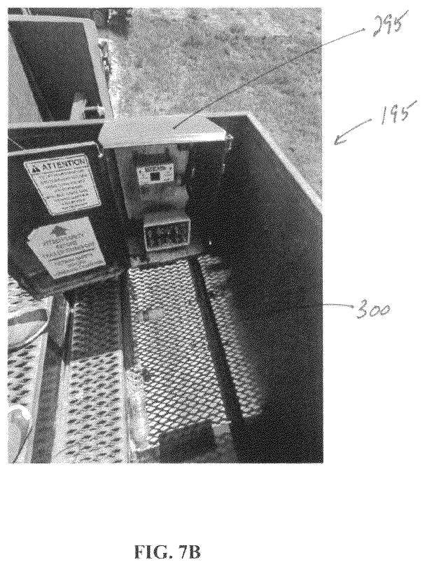

As shown in FIGS. 7A and 7B, in embodiments the control system 195 may comprise a hydraulic solenoid panel 285, one or more hydraulic solenoids 290, and a hydraulic valve control box 295. In embodiments, the hydraulic solenoid panel 285 may control the one or more hydraulic solenoids 290. In embodiments, the one or more hydraulic solenoids 290 may control the silo valves 210. In embodiments, the hydraulic valve control box 295 may be supported by a hydraulic valve controller platform 300.

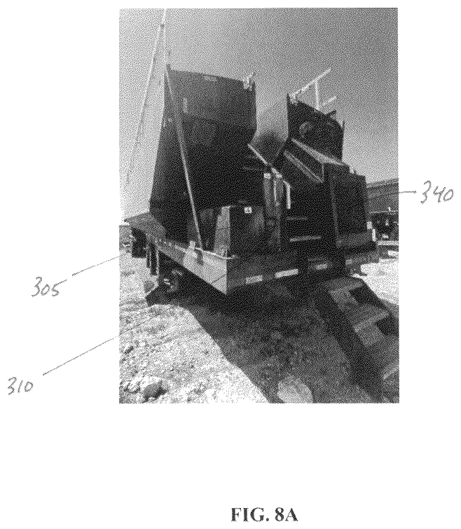

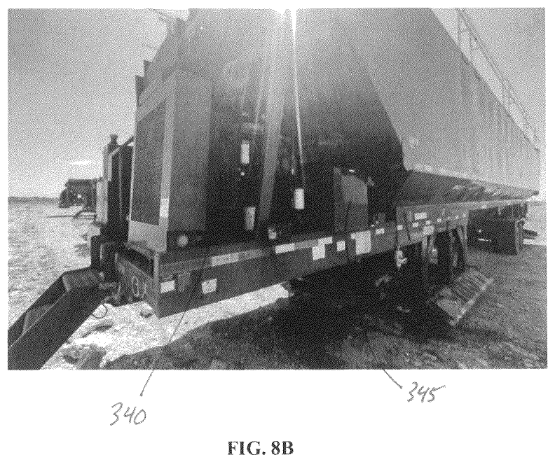

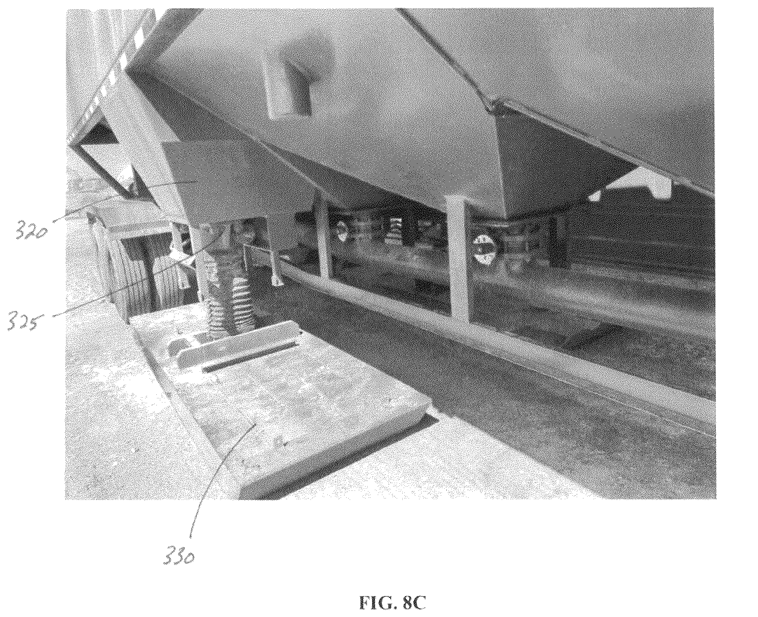

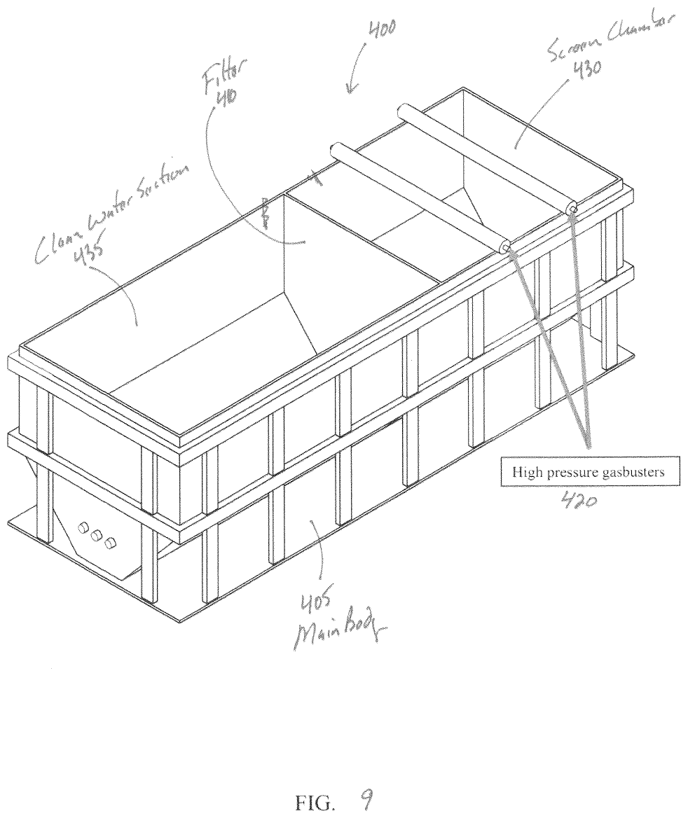

Referring to FIGS. 8A, 8B, and 8C, in embodiments the trailer 115 may comprise one or more fuel tanks 305, one or more oil tanks 310, one or more landing gear housings 320, a hydraulic motor 325, one or more stabilizer jacks 330, a hydraulic power supply 340, and an engine control panel 345.

FIG. 2 shows an embodiment of the pump trailer 120. In embodiments, the pump trailer 120 may comprise a first pump 350 and a second pump 355. In embodiments, the first pump 350 may be attached to the circulation inlet port 170. In embodiments, the first pump 350 may pump water into the self-cleaning tank 110. In embodiments, the second pump 355 may be attached to the discharge port 280. In embodiments, the second pump 355 may pump the sand mixture to the pit 370 or to the dewatering roll off gas buster 400, which is discussed below.

Wellbores accumulate a great deal of debris and sand from various downhole operations including fracking. Thus, there are times when there is a need to clean out the debris and sand from the wellbore in order to continue operations and/or production. In embodiments, the debris and sand may be pumped out of the wellbore to the gas buster attachment 105, which is located on the top of the self-cleaning tank 110. In embodiments, there are various types of attachments that may be used depending on the needs and regulations in the area where the wellbore is located. In addition to debris and sand, the downhole materials may also include water and liquid chemicals. Further, the downhole materials may also include gas. In some instances, this gas may be vented to the atmosphere, or the gas may be captured depending on the applicable regulations. Different types of attachments may be employed depending, in part, on the applicable regulations. Thus, in embodiments the goal is to deal with the gas, liquids, and solids, such as sand and debris, being removed from the wellbore.

In embodiments, the gas buster attachment 105 may act as a separator to remove the gas from the fluids. As stated above, in embodiments, the gas may be vented to the atmosphere or captured depending on the applicable regulations. In embodiments, the remaining materials, including the sand and debris, may proceed to the self-cleaning tank 110.

In embodiments, the sand, debris, water, and liquid chemicals may be deposited into the one or more silos 145 of the self-cleaning tank 110. In embodiments, even in situations where the one or more silos 145 appear to be full of merely sand, there may in fact be a liquid component as well. In embodiments, the liquid component may comprise water and chemicals.

In embodiments, the one or more skimmers 150 may be employed to hold the chemicals back while the water may exit the one or more silos 145 through the excess water port 155. In embodiments, this water may proceed into the excess water piping 160 and exit the self-cleaning tank 110 through the clean water exit port 165. In embodiments, the water may be sent to a plant located near the self-cleaning tank 110 so that the water may be treated and reused in the gas buster tank system 100.

In embodiments, once the one or more silos 145 are filled with sand to a sufficient level, the first pump 350 of the pump trailer 120 may be attached to the circulation inlet port 170. In embodiments, the first pump 350 may send water into the gas buster tank system 100. More specifically, the water may be sent through the circulation inlet port 170 into the circulation piping loop 175, where it may then be sent into the one or more perimeter jets 225 and the valve jets 230 in order to mix with the sand in the one or more silos 145. In embodiments, the addition of the water into the one or more silos 145 may create a suspension of sand and water (“the sand mixture”), which may be movable. In embodiments, any excess water may be removed from the one or more silos 145 through the excess water port 155. In embodiments, the circulation valves 235 may be employed to control the flow of water into the one or more silos 145.

In embodiments, once the sand mixture is created, the silo valves 210 may be actuated to open in order to allow the sand mixture to move into the one or more pipe arms 275 and then into the exit line 190. In embodiments, the sand mixture may move through the exit line 190 toward the discharge port 280. In embodiments, the second pump 355 of the pump trailer 120 may be attached to the discharge port 280. In embodiments, the sand mixture may be pumped by the second pump 355 to a pit 370 or to the dewatering roll off gas buster 400. In embodiments, the dewatering roll off gas buster 400 may comprise a filter to hold the sand and allow clean water to be pumped back to the circulation inlet port 170 to be reused.

In embodiments, the one or more silos 145 may be positioned in series with the one or more baffles 180, which may allow clean water to be moved between and among the one or more silos 145 to account for nonuniformity in the water distribution between and among the one or more silos 145.

Additionally, in embodiments there may be a need to measure and monitor the amount of pressure of sand, debris, and other downhole materials entering the one or more silos 145. In embodiments, the flow meter system 185 may be employed to perform these measurements and allow for monitoring of the pressure. In embodiments, this measuring and monitoring may be needed in order to ensure that the maximum amount of materials allowed into the gas buster tank system 100 is not being exceeded. Otherwise, too much material may overburden the gas buster tank system 100 or even result in the production of oil and/or gas that may corrupt the gas buster tank system 100 such that the gas buster tank system 100 is inoperable. In embodiments, a certain amount of the sand mixture contained in the one or more silos 145 may be routed into the flow meter port 265 of the inlet pipe 235. In embodiments, the sand mixture may proceed past the flow meter 240 before returning to the one or more silos 145 via the return pipe 260. In embodiments, the flow meter 240 may be wired to the flow meter display 255, which may provide the operator with information on the amount of flow, and therefore the pressure, being introduced into the gas buster tank system 100 from the wellbore.

In embodiments, the gas buster tank system 100 may be controlled hydraulically. For example, in embodiments the silo valves 210, the circulation valves 235, and the flow valves 250 may all be controlled hydraulically. Further, in embodiments the one or more silos 145 may hold between 200,000 to 250,000 pounds of sand. In embodiments, the gas buster tank system 100 may comprise a central command post for the operator where the operator may also control the first pump 350, the second pump 355, and any other pumps associated with the gas buster tank system 100.

Generally, the above describes an improved process and system for processing gas, liquids, and solids removed from a wellbore after various downhole operations, such as fracking.

Additionally, alternative embodiments may further comprise a dewatering roll off gas buster 400. In embodiments, the dewatering roll off gas buster 400 may filter sand from oil and gas production fluid. In embodiments, the dewatering roll off gas buster 400 may be used to capture and separate large volumes of gas within drilling fluid. In embodiments, the dewatering roll off gas buster 400 may also eliminate sand from oil and production fluid. In embodiments, the dewatering roll off gas buster 400 may be connected in series to easily and efficiently filter oil and production fluid. In embodiments, the dewatering roll off gas buster 400 may comprise a main body 405, a filter 410, a plurality of ports 415, a plurality of gas busters 420, and a flange 425. In embodiments, the filter 410 may prevent solids from mixing into the production fluid or oil. In embodiments, the production fluid may circulate through the dewatering roll off gas buster 400 until the production fluid is clean.

In embodiments, the dewatering roll off gas buster 400 may be capable of hooking up high pressure lines (not shown) in series. In embodiments, the dewatering roll off gas buster 400 may filter out sand from oil and gas production fluid. In order to accomplish this, in embodiments the dewatering roll off gas buster 400 may comprise the main body 405, wherein the main body 405 may allow fluids to drip to the bottom of the dewatering roll off gas buster 400. Further, in embodiments the filter 410 may screen out any solids within the production fluid. Additionally, in embodiments the plurality of ports 415 may allow the dewatering roll off gas buster 400 to be connected in series with additional dewatering roll off gas busters 400. Further, in embodiments the plurality of gas busters 420 may create connections for the high-pressure lines (not shown). In embodiments, the flange 425 may create a section wherein the filtered solids can be removed from the dewatering roll off gas buster 400.

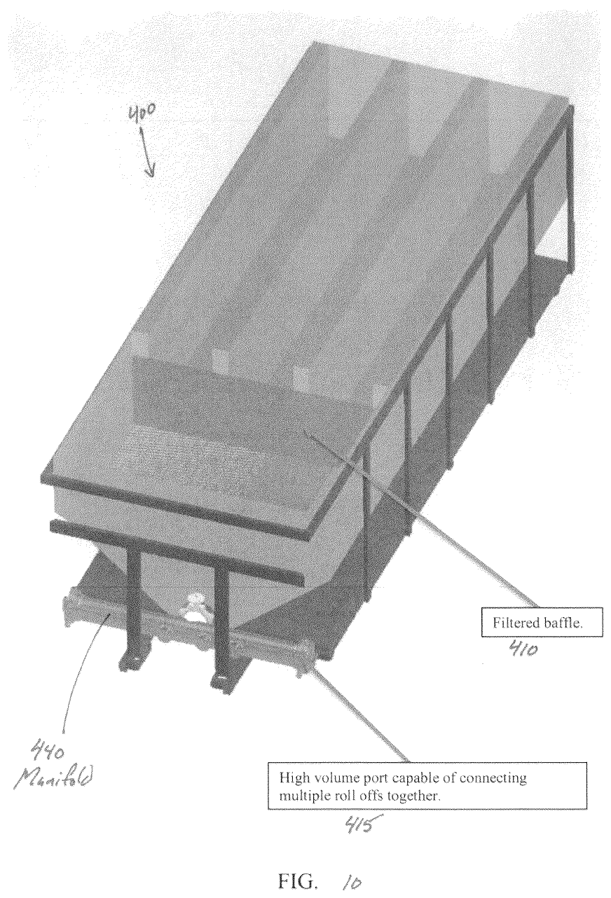

As shown in FIGS. 9-10, the dewatering roll off gas buster 400 may filter sand from oil and gas production fluid at a high volume. In embodiments, the dewatering roll off gas buster 400 may allow production fluid to flow through the filter 410 before leaving to external clean water tanks. In embodiments, the filter 410 may be positioned centrally within the main body 405 with the plurality of ports 415 fixed along the front side of the main body 405. In embodiments, the plurality of gas busters 420 may be positioned along the top side of the main body 405 and the flange 425 may be positioned along the bottom side of the main body 405.

In embodiments, the dewatering roll off gas buster 400 may hold the production fluid with the main body 405. In embodiments, the main body 405 may comprise a metal material with a rectangular shape and a V-shape at the bottom. In embodiments, this design may allow for the fluid to easily drip to the bottom of the dewatering roll off gas buster 400. In embodiments, the main body 405 may comprise a screen chamber 430 and a clean water section 435. In embodiments, the screen chamber 430 may be located along the rear side of the main body 405 as shown in FIG. 9. In embodiments, the screen chamber 430 may hold the production fluid before it is filtered through the filter 410. In embodiments, as the production fluid flows from the screen chamber 430, it may move into the clean water section 435 located in the front side of the main body 405. In embodiments, the main body 405 may comprise many various shapes and sizes, and the V-shape may be designed with various angles of steepness.

In embodiments, the filter 410 may connect with the main body 405 in a central section offset where the V-shape begins as seen in FIG. 9. In embodiments, the filter 410 may be designed with a rectangular shape. In embodiments, the filter 410 may comprise a screen with a small mesh size that may allow the filter 410 to filter out solids from the production fluid as it drips down within the main body 405. In embodiments, this design may allow for the production fluid to pass through the filter 410 at least one time to remove any unwanted solids from the production fluid or oil before it moves into the clean water section 435.

In embodiments, the plurality of ports 415 may be flanged and may be positioned on the front side of the main body 405 as seen in FIG. 10. In embodiments, the plurality of ports 415 may comprise a manifold 440 that may allow for external connections into the main body 405. In embodiments, this design may allow for three or four dewatering roll off gas busters 400 to be connected in series, which may increase the volume of fluid held within the main body 405. In embodiments, this may create an adjustable production fluid flow, linking up the clean water at the bottom of the main body 405. In embodiments, by placing multiple main bodies 405 in a row, more space may be created for multiple dewatering roll off gas busters 400 to be placed offset to increase the volume of fluid in the dewatering roll off gas busters 400.

In embodiments, the plurality of gas busters 420 may be positioned above the main body 405 and perpendicular to the sides of the main body 405 as seen in FIG. 9. In embodiments, the plurality of gas busters 420 may be externally connected to high-pressure lines. In embodiments, the plurality of gas busters 420 may allow for the production fluid to initially be introduced into the dewatering roll off gas buster 400. In embodiments, as the production fluid flows through the plurality of gas busters 420 it may be dispersed into the main body 405 before the filter 410 in order to allow solids to be removed from the production fluid.

In embodiments, the flange 425 may be positioned on the rear bottom of the main body 405 as seen in FIG. 9. In embodiments, the flange 425 may be a sealed flange door that creates an airtight seal on the rear bottom of the dewatering roll off gas buster 400. In embodiments, the flange 425 may be designed with a rectangular shape with a hinge that allows for the solids to be easily removed from the dewatering roll off gas buster 400 as they are filtered out from the production fluid.

1. A gas buster tank system, comprising:
a self-cleaning tank, wherein the self-cleaning tank comprises:
a gas buster attachment port,
one or more silos, wherein each of the one or more silos comprises a valve,
one or more skimmers,
an excess water port,
excess water piping,
a clean water exit port,
a circulation inlet port,
a circulation piping loop,
one or more baffles,
an exit line, wherein the exit line comprises one or more pipe arms and a discharge port, and
a control system;
a gas buster attachment, wherein the gas buster attachment is attached to the gas buster attachment port;
a trailer; and
a pump trailer, wherein the pump trailer comprises a first pump attached to the circulation inlet port and a second pump attached to the discharge port.

2. The gas buster tank system of claim 1, wherein each of the one or more silos comprises a rectangular section and a V-shaped section.

3. The gas buster tank system of claim 1, wherein the clean water exit port comprises one or more butterfly valves.

4. The gas buster tank system of claim 1, wherein the circulation piping loop comprises a plurality of circulation valves, a plurality of perimeter jets, and a plurality of valve jets.

5. The gas buster tank system of claim 1, wherein the system further comprises a flow meter system, wherein the flow meter system comprises:
an inlet pipe;
a flow meter;
Victaulic clamps;
one or more flow valves;
a flow meter display; and
a return pipe.

6. A method of processing gas, liquids, and solids removed from a wellbore, comprising:
providing a gas buster tank system comprising:
a self-cleaning tank, wherein the self-cleaning tank comprises:
a gas buster attachment port,
one or more silos, wherein each of the one or more silos comprises a valve,
one or more skimmers,
an excess water port,
excess water piping,
a clean water exit port,
a circulation inlet port,
a circulation piping loop,
one or more baffles,
an exit line, wherein the exit line comprises one or more pipe arms and a discharge port, and
a control system,
a gas buster attachment, wherein the gas buster attachment is attached to the gas buster attachment port,
a trailer, and
a pump trailer, wherein the pump trailer comprises a first pump attached to the circulation inlet port and a second pump attached to the discharge port;
pumping materials from a wellbore, wherein the materials comprise sand, debris, water, and liquid chemicals;
directing the materials to the gas buster attachment, wherein the gas buster attachment separates gas from the materials;
directing the remaining materials to the self-cleaning tank, wherein the materials are deposited in the one or more silos;
holding the chemicals in the materials back by employing the one or more skimmers while allowing the water in the materials to proceed through the excess water port, wherein the water exits the self-cleaning tank via the clean water exit port;
attaching the first pump to the circulation inlet port, wherein water is pumped into the circulation piping loop, wherein it is sent through the perimeter jets and valve jets to mix with the sand in the one or more silos;
actuating the one or more silo valves allowing the sand mixture to move into the one or more pipe arms and into the exit line; and
attaching the second pump to the discharge port to pump the sand mixture out of the self-cleaning tank.

7. The method of claim 6, wherein the water exits the clean water exit port and proceeds to a plant to be treated and reused.

8. The method of claim 6, wherein the circulation valves control the flow of water into the one or more silos.

9. The method of claim 6, wherein the sand mixture is sent to a pit.

10. The method of claim 6, wherein the sand mixture is sent to a dewatering roll off gas buster.

11. The method of claim 6, wherein there is a plurality of silos.

12. The method of claim 11, wherein the baffles permit clean water to move between the plurality of silos.
